(19) United States
(12) Patent Application Publication
(10) Pub. No.: US 2010/0239918 A1
(43) Pub. Date: Sep. 23, 2010

(54) NANOPARTICLE-BLOCK COPOLYMER COMPOSITES FOR SOLID IONIC ELECTROLYTES

(75) Inventors: Russell Clayton Pratt, Oakland, CA (US); Michael Geier, Oakland, CA (US)

Correspondence Address: SEEO, INC., 626 BANCORFT WAY, SUITE 3B, BERKELEY, CA, 94710, US

(73) Assignee: SEEO, INC, Berkeley, CA (US)

(21) Appl. No.: 12/724,369

(22) Filed: Mar. 15, 2010

Related U.S. Application Data
(60) Provisional application No. 61/161,026, filed on Mar. 17, 2009.

(51) Int. Cl. H01M 6/18

(52) U.S. Cl. 429/307

(57) ABSTRACT

A microphase separated polymer has nano-domains and inorganic nanoparticles within at least one of the domains. The nanoparticle size is chosen to be substantially smaller than the domain size. For example, for the case of lamellar domains, the nanoparticle size is smaller than the width of the domain. This allows the nanoparticles to affect the bulk properties of the domain phase, such as the overall ionic conductivity or mechanical properties. The nanoparticles can be any of a number of inorganic oxides such as alumina, silica, or titania.

### CROSS-REFERENCE TO RELATED APPLICATIONS

This application claims priority to U.S. Provisional Patent Application 61/161,026, filed Mar. 17, 2009, which is incorporated by reference herein.

### BACKGROUND OF THE INVENTION

### Field of the Invention

This invention relates generally to high-conductivity block copolymer electrolytes, and, more specifically, to the use of nanoparticles to enhance conductivity in such electrolytes.

Interest in rechargeable batteries has grown steadily as the global demand for technological products such as cellular phones, laptop computers and other consumer electronic products has escalated. In addition, interest in rechargeable batteries has been fueled by current efforts to develop green technologies such as electrical grid load-leveling devices and electrically-powered vehicles, which are creating a large market for rechargeable batteries with high energy densities.

Li-ion batteries are some of the most popular types of rechargeable batteries for portable electronics. Li-ion batteries offer high energy and power densities, slow loss of charge when not in use, and do not suffer from memory effects. Because of these benefits, Li-ion batteries have also found use in defense, aerospace, back-up storage, and transportation applications.

The electrolyte is an important part of a Li-ion rechargeable battery. Traditional Li-ion rechargeable batteries have employed liquid electrolytes. An exemplary liquid electrolyte is a lithium-salt electrolyte, such as LiPF₆, LiBF₄, or LiClO₄, mixed with an organic solvent, such as an alkyl carbonate. During discharging, as a negative electrode material is oxidized, producing electrons, and a positive electrode material is reduced, consuming electrons, the electrolyte serves as a medium for ion flow between the electrodes. The electrons flow between the electrodes through an external circuit.

As liquid electrolytes have dominated current Li-based battery technologies, solid electrolytes may constitute the next wave of advances for Li-based batteries. Solid polymer electrolytes are especially attractive for Li-ion batteries because, among other benefits, solid polymer electrolytes offer high thermal stability, low rates of self-discharge, stable operation over a wide range of environmental conditions, enhanced safety, flexibility in battery configuration, minimal environmental impacts, and low materials and processing costs. Moreover, solid polymer electrolytes may enable the use of lithium metal anodes, which offer higher energy densities than traditional lithium ion anodes.

Polymeric electrolytes have been the subject of academic and commercial battery research for several years. Polymer electrolytes have been of exceptional interest partly due to their low reactivity with lithium and their potential to act as a barrier to the formation of metallic lithium filaments, or dendrites, upon cycling.

According to one example, polymer electrolytes are formed by incorporating lithium salts into appropriate polymers to create electronically insulating media that are also ionically conductive. Such polymers can act both as solid state electrolytes and as separators in primary or secondary batteries. Such polymer electrolytes can form the basis for solid state batteries with low rates of self-discharge, stability over a wide range of temperatures and environmental conditions, enhanced safety, and higher energy densities as compared to conventional liquid-electrolyte batteries.

Despite their many advantages, polymer electrolytes have not received wide acceptance as it has been difficult to develop a polymer electrolyte that has both high ionic conductivity and good mechanical properties. Some believe that the difficulty arises because the same high polymer chain mobility that is useful in achieving high ionic conductivity leads to undesirably soft mechanical properties.

One approach to enhance the conductivity of polymer electrolytes has been to incorporate inorganic nanoparticles into the electrolytes. Another approach to improve polymer electrolytes has focused on retaining dimensional stability without compromising ionic conductivity by using block copolymer electrolyte sysₜems. Self-assembled block-copolymers can include domains of ionically-conductive polymer within a non-conductive polymer matrix that provides mechanical support. A salt is incorporated into the ionically-conductive phase to enhance conductivity.

Unfortunately, an optimal solid polymer electrolyte, one that has very high ionic conductivity and mechanical stability, has not yet been made. There is need for further development of these materials.

### BRIEF DESCRIPTION OF THE DRAWINGS

The foregoing aspects and others will be readily appreciated by the skilled artisan from the following description of illustrative embodiments when read in conjunction with the accompanying drawings.

FIG. 1 is a schematic illustration of a polymer with nanostructured domains.

FIGS. 2A and 2B are schematic illustrations of two different ways in which a large nanoparticle might be incorporated into the polymer of FIG. 1.

FIG. 3 is a schematic illustration of a plurality of small nanoparticles that have been incorporated preferentially in one domain type into the polymer of FIG. 1, according to an embodiment of the invention.

FIG. 4 is a schematic drawing of a diblock copolymer and a domain structure it can form.

FIG. 5 is a schematic drawing of a triblock copolymer and a domain structure it can form.

FIG. 6 is a schematic drawing of a triblock copolymer and a domain structure it can form.

### DETAILED DESCRIPTION

The preferred embodiments are illustrated in the context of multi-domain polymer electrolytes in which nanoparticles are added to the ionically conductive domains to increase conductivity. The skilled artisan will readily appreciate, however, that the materials and methods disclosed herein will have application in a number of other contexts where incorporation of nanoparticles into nanostructured domains is desirable, particularly where the nanoparticles can be used to modify domain properties.

These and other objects and advantages of the present invention will become more fully apparent from the following description taken in conjunction with the accompanying drawings.

All publications referred to herein are incorporated by reference in their entirety for all purposes as if fully set forth herein.

The term “particle size” is used herein to mean the smallest dimension of the particle. In the case of equiaxed particles, the particle size is the diameter. In the case of elongated particles, the particle size is the width (smallest dimension) rather than the length (largest dimension).

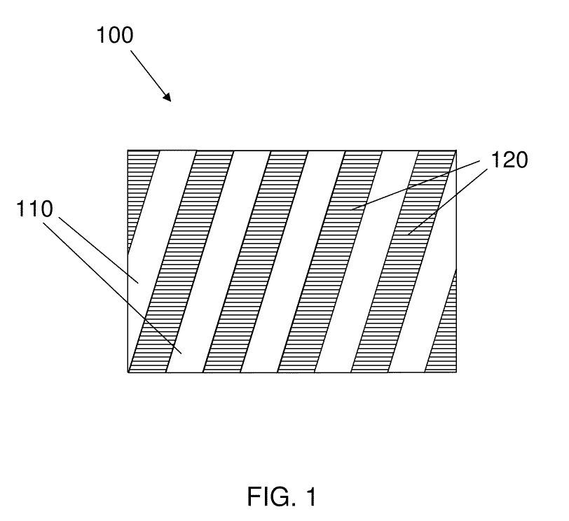

FIG. 1 shows a microphase-separated polymer 100 that has lamellar nano-domains 110, 120. Materials for each nano-domain are chosen to contribute desirable properties to the overall polymer 100. In one example, the polymer 100 can be used as an electrolyte in an electrochemical system, such as a battery. Domain 110 contains polar molecules capable of ionic conduction. Domain 120 contains non-polar molecules and provides mechanical strength.

It is well known that additives can be used to enhance material properties. Yet an additive that enhances the properties of one material may affect the properties of another material in an adverse way. For example, an additive that promotes cross-linking in a polymer can enhance mechanical strength. Yet if the same additive were added to a polymer that provides ionic conductivity, the cross-linking would decrease the ionic conductivity, an adverse result.

It is counterproductive to distribute an additive throughout an entire microphase-separated polymer if it enhances the properties of one domain and compromises the properties of other domain(s). Furthermore, when such a polymer is used as an electrolyte, weight and volume are very important. Even if an additive has no adverse effect on the domain(s) for which it is not intended, it still adds unnecessary weight and/or volume to those domain(s). Although additives may provide many benefits, it is more efficient to use such additives sparingly and only where they participate actively in improving properties.

Nanoparticles can increase the ionic conductivity of some polymer electrolyte materials. Without wishing to be bound to any particular theory, it may be that nanoparticles enhance ionic conductivity by reducing the polymer glass transition temperature and/or by reducing the crystallinity of the polymer. Thus, it would be useful to incorporate nanoparticles into a microphase-separated polymer so that they are incorporated either exclusively or preferentially into the ionically conductive domain, and they are not incorporated into other domain(s) where their effect would be benign at best. Incorporation of nanoparticles into domains where they provide no desirable effect adds weight and volume to the overall polymer and wastes material.

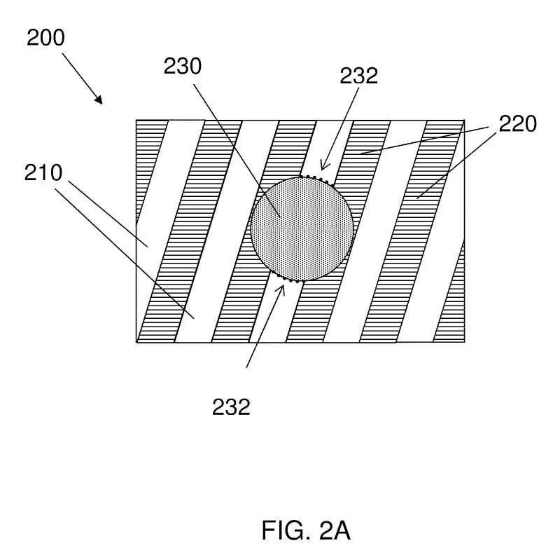

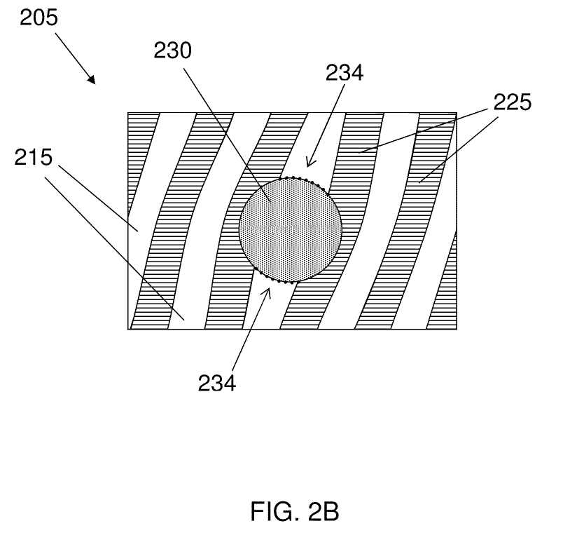

In FIG. 2A, a nanoparticle 230 has been added to a microphase-separated polymer 200. The nanoparticle 230 is much larger than the width of either ionically-conductive nano-domain 210 or structural nano-domain 220 and therefore cannot be contained in any one nano-domain. Instead, several of the nano-domains 210, 220 are in contact with the nanoparticle 230. In some cases, as shown in FIG. 2A, the nanoparticle 230 does not change the overall structure of the nano-domains 210, 220. In one arrangement, the nano-domains 210, 220 have a width between about 10 and 1000 nm. In another arrangement, the nano-domains 210, 220 have a width between about 50 and 500 nm. In another arrangement, the nano-domains 210, 220 have a width between about 50 and 150 nm. In another arrangement, the nano-domains 210, 220 have a width between about 75 and 125 nm.

In FIG. 2B, nanoparticle 230 is included in another microphase-separated polymer 205 that contains ionically-conductive nano-domains 215 and structural nano-domains 225. The nanoparticle 230 has distorted the nano-domain structure of the polymer 205. Interaction between the nanoparticle 230 and the nano-domains 215, 225 has caused the nano-domains to become distorted in the region around the nanoparticle 230. In the polymer 205, the nanoparticle 230 alters both orientation and morphology of the nano-domains.

If, for example, the purpose of adding the nanoparticle 230 to the microphase-separated polymers 200, 205 is to enhance the properties of the ionically-conductive nano-domains 210, 215, then the way the nanoparticle 230 has incorporated itself into the systems 200, 205, as shown in FIGS. 2A and 2B, is sub-optimal. Only portions of the surface of the nanoparticle 230, as indicated by dotted regions 232, 234, are in contact with the nano-domains 210, 215, respectively. The remaining surfaces of the nanoparticle 230 are in contact with the nano-domains 220, 225, which may be unaffected or adversely affected by the nanoparticles 230. Thus, much of the surface of the nanoparticle 230 cannot interact with the ionically-conductive domains 210, 215 and is not helping to increase ionic conductivity.

In another arrangement (not shown), when nanoparticles are as large or larger than the widths of the domains, one or another domain may rearrange itself to coat the nanoparticles, further distorting the structure of the block copolymer.

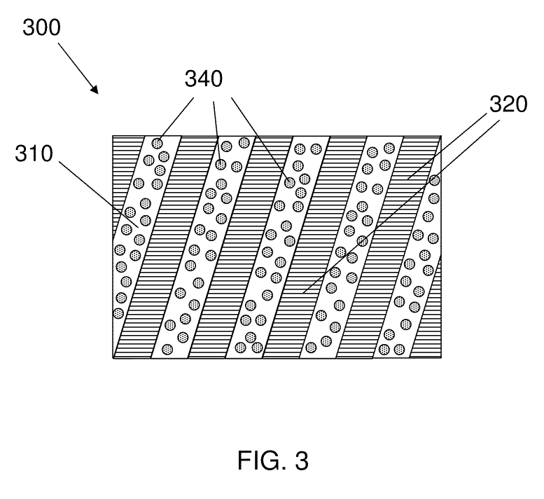

In a microphase-separated polymer where each nano-domain has very different properties, it can be useful to target additives to enhance desired properties in a specific nano-domain. In one embodiment of the invention, nanoparticles are incorporated into only the ionically-conductive nano-domains of a microphase-separated block copolymer. Such an arrangement is shown in FIG. 3. A microphase-separated polymer 300 has ionically-conductive nano-domains 310 and structural nano-domains 320. The nano-domains 310 have nanoparticles 340 distributed throughout. The conductive nano-domains 310 contain polar molecules capable of ionic conduction. Surfaces of the nanoparticles 340 are also generally polar, so the nanoparticles 340 are attracted to the ionically conductive domains 310 and not to the structural domains 320. Thus desirable conductive properties of the nano-domains 310 are enhanced by the nanoparticles 340. By including the nanoparticles only in the nano-domains where they are useful, the interaction between the polymer in those nano-domains and the nanoparticles is maximized.

In one arrangement the nanoparticles are distributed randomly throughout only one kind of nano-domain, as shown in FIG. 3. In another arrangement (not shown), the nanoparticles are also in only one kind of nano-domain, but are distributed preferentially along the boundaries of the domain. By incorporating the nanoparticles within nano-domains, there are no significant long range effects on the structure or orientation of the block copolymer.

In one embodiment of the invention, the nanoparticles comprise ceramic materials, that is, inorganic, nonmetallic, non-molecular materials including amorphous and crystalline, porous and non-porous materials. While any suitable ceramic particle can be used, some examples include, but are not limited to, Al₂O₃, SiO₂, TiO₂, MgO, ZrO₂, Nb₂O₅, Cr₂O₃, SnO₂, Fe₂O₃, and PbO; blends of metal oxides such as SiO₂/Al₂O₃; various phases of ceramic materials such as alpha-alumina, beta-alumina, or gamma-alumina; mixed metal oxides such as aluminosilicates, BaTiO₃, or BPO₄; fumed metal oxides such as fumed silica; synthetic or natural clays; zeolites; or layered double hydroxides and organosilicates (e.g., Class I and Class II). The ceramic particle may also contain lithium, such as LiAlO₂ or Li₃N. In one arrangement, the nanoparticles have a size less than about 75% of the domain width. In another arrangement, the nanoparticles have a size less than about 50% of the domain width. In yet another arrangement, the nanoparticles have a size less than about 25% of the domain width. In one arrangement, the nanoparticles have a size between about 2.5 and 50 nm. In another arrangement, the nanoparticles have a size between about 2.5 and 15 nm.

### Nanostructured Block Copolymer Electrolytes

As described in detail above, a block copolymer electrolyte can be used in the embodiments of the invention.

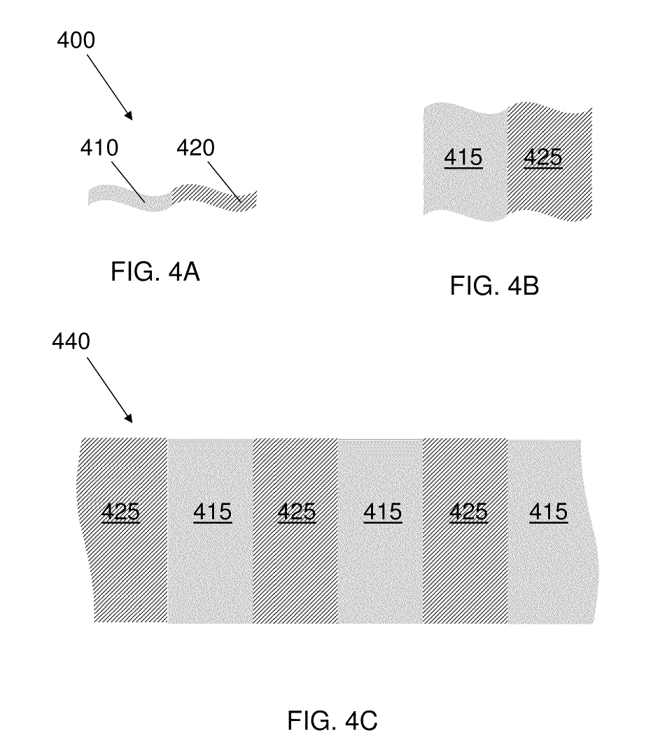

FIG. 4A is a simplified illustration of an exemplary diblock polymer molecule 400 that has a first polymer block 410 and a second polymer block 420 covalently bonded together. In one arrangement both the first polymer block 410 and the second polymer block 420 are linear polymer blocks. In another arrangement, either one or both polymer blocks 410, 420 has a comb (or branched) structure. In one arrangement, neither polymer block is cross-linked. In another arrangement, one polymer block is cross-linked. In 5et another arrangement, both polymer blocks are cross-linked.

Multiple diblock polymer molecules 400 can arrange themselves to form a first domain 415 of a first phase made of the first polymer blocks 410 and a second domain 425 of a second phase made of the second polymer blocks 420, as shown in FIG. 4B. Diblock polymer molecules 400 can arrange themselves to form multiple repeat domains, thereby forming a continuous nanostructured block copolymer material 440, as shown in FIG. 4C. The sizes or widths of the domains can be adjusted by adjusting the molecular weights of each of the polymer blocks.

In one arrangement the first polymer domain 415 is ionically conductive, and the second polymer domain 425 provides mechanical strength to the nanostructured block copolymer.

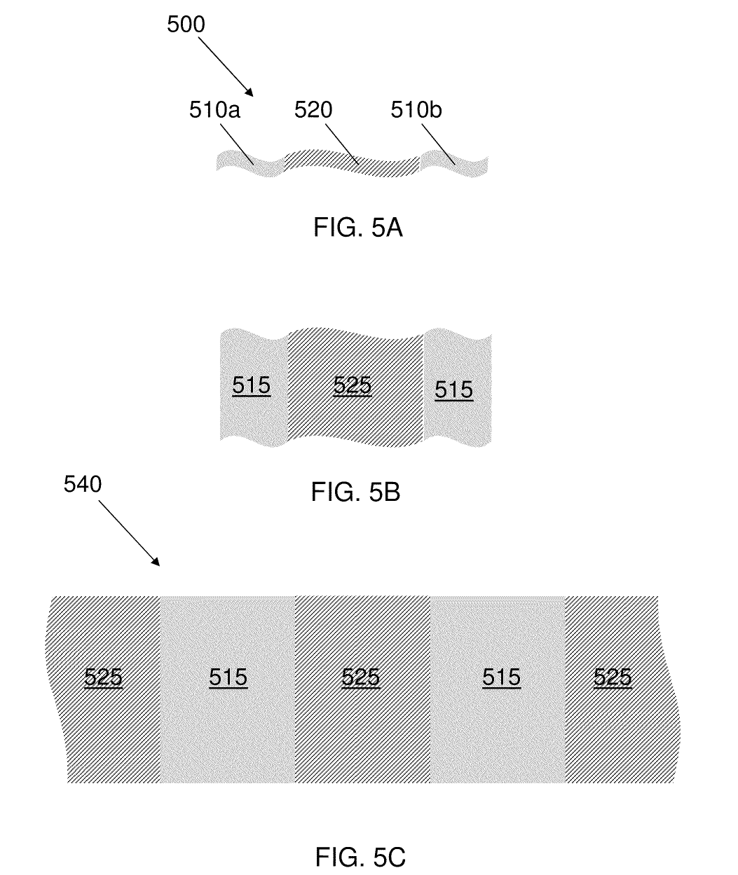

FIG. 5A is a simplified illustration of an exemplary triblock polymer molecule 500 that has a first polymer block 510a, a second polymer block 520, and a third polymer block 510b that is the same as the first polymer block 510a, all covalently bonded together. In one arrangement the first polymer block 510a, the second polymer block 520, and the third copolymer block 510b are linear polymer blocks. In another arrangement, either some or all polymer blocks 510a, 520, 510b have a comb (or branched)structure. In one arrangement, no polymer block is cross-linked. In another arrangement, one polymer block is cross-linked. In 5et another arrangement, two polymer blocks are cross-linked. In 5et another arrangement, all polymer blocks are cross-linked.

Multiple triblock polymer molecules 500 can arrange themselves to form a first domain 515 of a first phase made of the first polymer blocks 510a, a second domain 525 of a second phase made of the second polymer blocks 520, and a third domain 515b of a first phase made of the third polymer blocks 510b as shown in FIG. 5B. Triblock polymer molecules 500 can arrange themselves to form multiple repeat domains 525, 515 (containing both 515a and 515b), thereby forming a continuous nanostructured block copolymer 530, as shown in FIG. 5C. The sizes of the domains can be adjusted by adjusting the molecular weights of each of the polymer blocks.

In one arrangement the first and third polymer domains 515a, 515b are ionically conductive, and the second polymer domain 525 provides mechanical strength to the nanostructured block copolymer. In another arrangement, the second polymer domain 525 is ionically conductive, and the first and third polymer domains 515 provide a structural framework.

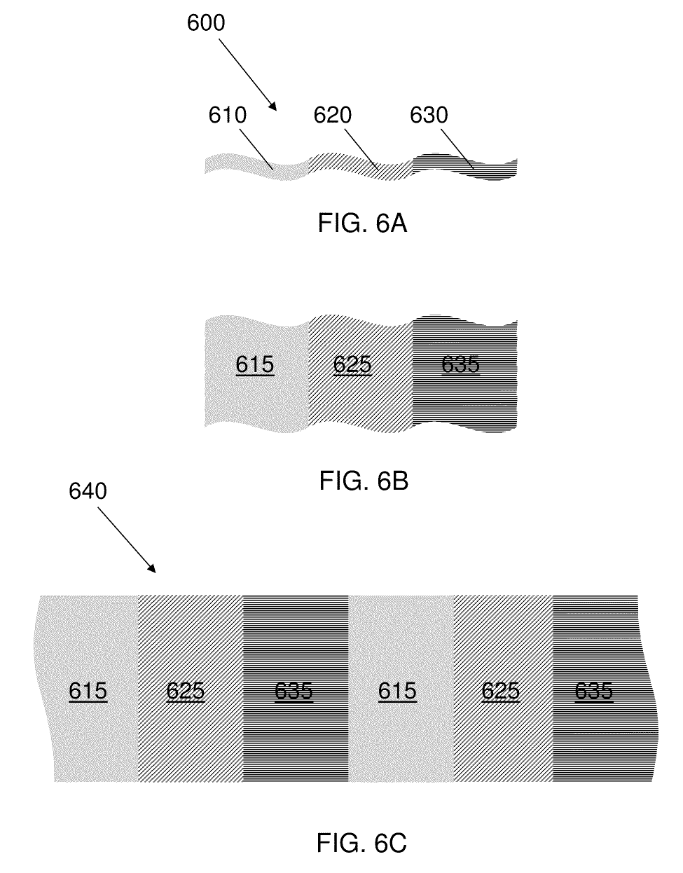

FIG. 6A is a simplified illustration of another exemplary triblock polymer molecule 600 that has a first polymer block 610, a second polymer block 620, and a third polymer block 630, different from either of the other two polymer blocks, all covalently bonded together. In one arrangement the first polymer block 610, the second polymer block 620, and the third copolymer block 630 are linear polymer blocks. In another arrangement, either some or all polymer blocks 610, 620, 630 have a comb (or branched)structure. In one arrangement, no polymer block is cross-linked. In another arrangement, one polymer block is cross-linked. In 5et another arrangement, two polymer blocks are cross-linked. In 5et another arrangement, all polymer blocks are cross-linked.

Multiple triblock polymer molecules 600 can arrange themselves to form a first domain 615 of a first phase made of the first polymer blocks 610a, a second domain 625 of a second phase made of the second polymer blocks 620, and a third domain 635 of a third phase made of the third polymer blocks 630 as shown in FIG. 6B. Triblock polymer molecules 600 can arrange themselves to form multiple repeat domains, thereby forming a continuous nanostructured block copolymer 640, as shown in FIG. 6C. The sizes of the domains can be adjusted by adjusting the molecular weights of each of the polymer blocks.

In one arrangement the first polymer domains 615 are ionically conductive, and the second polymer domains 625 provide mechanical strength to the nanostructured block copolymer. The third polymer domains 635 provides an additional functionality that may improve mechanical strength, ionic conductivity, chemical or electrochemical stability, may make the material easier to process, or may provide some other desirable property to the block copolymer. In other arrangements, the individual domains can exchange roles.

Choosing appropriate polymers for the block copolymers described above is important in order to achieve desired electrolyte properties. In one embodiment, the conductive polymer (1) exhibits ionic conductivity of at least 10⁻⁵ Scm⁻¹ at electrochemical cell operating temperatures when combined with an appropriate salt(s), such as lithium salt(s); (2) is chemically stable against such salt(s); and (3) is thermally stable at electrochemical cell operating temperatures. In one embodiment, the structural material has a modulus in excess of 1×10⁵ Pa at electrochemical cell operating temperatures. In one embodiment, the third polymer (1) is rubbery; and (2) has a glass transition temperature lower than operating and processing temperatures. It is useful if all materials are mutually immiscible.

In one embodiment of the invention, the conductive phase can be made of a linear or branched polymer. Conductive linear or branched polymers that can be used in the conductive phase include, but are not limited to, polyethers, polyamines, polyimides, polyamides, alkyl carbonates, polynitriles, and combinations thereof. The conductive linear or branched polymers can also be used in combination with polysiloxanes, polyphosphazines, polyolefins, and/or polydienes to form the conductive phase.

In another exemplary embodiment, the conductive phase is made of comb (or branched)polymers that have a backbone and pendant groups. Backbones that can be used in these polymers include, but are not limited to, polysiloxanes, polyphosphazines, polyethers, polydienes, polyolefins, polyacrylates, polymethacrylates, and combinations thereof. Pendants that can be used include, but are not limited to, oligoethers, substituted oligoethers, nitrile groups, sulfones, thiols, polyethers, polyamines, polyimides, polyamides, alkyl carbonates, polynitriles, other polar groups, and combinations thereof.

Further details about polymers that can be used in the conductive phase can be found in International Patent Application Number PCT/US09/45356, filed May 27, 2009, International Patent Application Number PCT/US09/54709, filed Aug. 22, 2009, International Patent Application Number PCT/US10/21065, filed Jan. 14, 2010, International Patent Application Number PCT/US10/21070, filed Jan. 14, 2010, U.S. International Patent Application Number PCT/US10/25680, filed Feb. 26, 2009, and U.S. International Patent Application Number PCT/US10/25690, filed Feb. 26, 2009, all of which are included by reference herein.

There are no particular restrictions on the electrolyte salt that can be used in the block copolymer electrolytes. Any electrolyte salt that includes the ion identified as the most desirable charge carrier for the application can be used. It is especially useful to use electrolyte salts that have a large dissociation constant within the polymer electrolyte.

Suitable examples include alkali metal salts, such as Li salts. Examples of useful Li salts include, but are not limited to, LiPF₆, LiN(CF₃SO₂)₂, Li(CF₃SO₂)₃C, LiN(SO₂CF₂CF₃)₂, LiB(C₂O₄)₂, B₁₂FₓH₁₂₋ₓ, B₁₂F₁₂, and mixtures thereof.

In one embodiment of the invention, single ion conductors can be used with electrolyte salts or instead of electrolyte salts. Examples of single ion conductors include, but are not limited to sulfonamide salts, boron based salts, and sulfates groups.

In one embodiment of the invention, the structural phase can be made of polymers such as polystyrene, hydrogenated polystyrene, polymethacrylate, poly(methyl methacrylate), polyvinylpyridine, polyvinylcyclohexane, polyimide, polyamide, polypropylene, polyolefins, poly(t-butyl vinyl ether), poly(cyclohexyl methacrylate), poly(cyclohexyl vinyl ether), poly(t-butyl vinyl ether), polyethylene, fluorocarbons, such as polyvinylidene fluoride, or copolymers that contain styrene, methacrylate, or vinylpyridine.

Additional species can be added to nanostructured block copolymer electrolytes to enhance the ionic conductivity, to enhance the mechanical properties, or to enhance any other properties that may be desirable.

The ionic conductivity of nanostructured block copolymer electrolyte materials can be improved by including one or more additives in the ionically conductive phase. An additive can improve ionic conductivity by lowering the degree of crystallinity, lowering the melting temperature, lowering the glass transition temperature, increasing chain mobility, or any combination of these. A high dielectric additive can aid dissociation of the salt, increasing the number of Li+ ions available for ion transport, and reducing the bulky Li+[salt] complexes. Additives that weaken the interaction between Li+ and PEO chains/anions, thereby making it easier for Li+ ions to diffuse, may be included in the conductive phase. The additives that enhance ionic conductivity can be broadly classified in the following categories: low molecular weight conductive polymers, ceramic particles, room temp ionic liquids (RTILs), high dielectric organic plasticizers, and Lewis acids.

Other additives can be used in the polymer electrolytes described herein. For example, additives that help with overcharge protection, provide stable SEI (solid electrolyte interface) layers, and/or improve electrochemical stability can be used. Such additives are well known to people with ordinary skill in the art. Additives that make the polymers easier to process, such as plasticizers, can also be used.

Further details about block copolymer electrolytes are described in U.S. patent application Ser. No. 12/225,934, filed Oct. 1, 2008, U.S. patent application Ser. No. 12/271,1828, filed Nov. 14, 2008, and International Patent Application Number PCT/US09/31356, filed Jan. 16, 2009, all of which are included by reference herein.

This invention has been described herein in considerable detail to provide those skilled in the art with information relevant to apply the novel principles and to construct and use such specialized components as are required. However, it is to be understood that the invention can be carried out by different equipment, materials and devices, and that various modifications, both as to the equipment and operating procedures, can be accomplished without departing from the scope of the invention itself.

We claim:

1. A polymer, comprising:
a first nanostructured domain, the first nanostructured domain being ionically conductive and further comprising nanoparticles having a size less than the width of the first nanostructured domain; and
a second nanostructured domain adjacent the first nanostructured domain.

2. The polymer of claim 1 wherein the first nanostructured domain comprises a material selected from the group consisting of polyethers, polyamines, polyimides, polyamides, alkyl carbonates, polynitriles, polysiloxanes, polyphosphazines, polyolefins, polydienes, and combinations thereof.

3. The polymer of claim 2 wherein the first nanostructured domain comprises an ionically-conductive comb polymer, which comb polymer comprises a backbone and pendant groups.

4. The polymer of claim 3 wherein the backbone comprises one or more selected from the group consisting of polysiloxanes, polyphosphazines, polyethers, polydienes, polyolefins, polyacrylates, polymethacrylates, and combinations thereof.

5. The polymer of claim 3 wherein the pendants comprise one or more selected from the group consisting of oligoethers, substituted oligoethers, nitrile groups, sulfones, thiols, polyethers, polyamines, polyimides, polyamides, alkyl carbonates, polynitriles, other polar groups, and combinations thereof.

6. The polymer of claim 1 wherein the nanoparticles have a size less than about 75% of the first domain width.

7. The polymer of claim 1 wherein the nanoparticles have a size less than about 50% of the first domain width.

8. The polymer of claim 1 wherein the nanoparticles have a size less than about 25% of the first domain width.

9. The polymer of claim 1 wherein the nanoparticles comprise a material selected from the group consisting of metal oxides, ceramics, and combinations thereof.

10. The polymer of claim 1 wherein the nanoparticles have a size between about 2.5 and 50 nm.

11. The polymer of claim 1 wherein the nanoparticles have a size between about 2.5 and 15 nm.

12. The polymer of claim 1 wherein the nanoparticles are distributed randomly throughout the first domain.

13. The polymer of claim 1 wherein the nanoparticles are distributed preferentially along boundaries of the first domain.

14. The polymer of claim 1 wherein the first nanostructured domain further comprises an electrolyte salt.

15. The polymer of claim 1 wherein the second nanostructured domain has a modulus in excess of 1×10⁵ Pa at 80° C.

16. The polymer of claim 1 wherein the second nanostructured domain comprises a material selected from the group consisting of polystyrene, hydrogenated polystyrene, polymethacrylate, poly(methyl methacrylate), polyvinylpyridine, polyvinylcyclohexane, polyimide, polyamide, polypropylene, polyolefins, poly(t-butyl vinyl ether), poly(cyclohexyl methacrylate), poly(cyclohexyl vinyl ether), poly(t-butyl vinyl ether), polyethylene, fluorocarbons, polyvinylidene fluoride, and copolymers that contain styrene, methacrylate, and/or vinylpyridine.

17. The polymer of claim 1 wherein the polymer comprises a block copolymer.

18. The polymer of claim 17 wherein the polymer comprises either a diblock copolymer or a triblock copolymer.

19. A polymer electrolyte, comprising:
a first nanostructured domain comprising ethylene oxide and metal oxide nanoparticles, the nanoparticles having a size less than the 75% the width of the first nanostructured domain; and
a second nanostructured domain comprising polystyrene, the second nanostructured domain adjacent the first nanostructured domain.

20. The electrolyte of claim 19 wherein the nanoparticles comprise a material selected from the group consisting of silica, titania, alumina, and combinations thereof.

21. The electrolyte of claim 19 wherein the nanoparticles have a size less than about 25% of the first domain width.

22. The electrolyte of claim 19 wherein the nanoparticles have a size between about 2.5 and 15 nm.
